(19) United States
(12) Patent Application Publication
(10) Pub. No.: US 2018/0270530 A1
(43) Pub. Date: Sep. 20, 2018

(54) METHOD AND APPARATUS FOR AUTOMATICALLY TURNING OFF VIDEO PLAYBACK

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yuanhang REN, BEIJING (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/119,550

(22) PCT Filed: May 27, 2016
(86) PCT No.: PCT/CN2016/083726

§ 371 Date: Aug. 17, 2016

(30) Foreign Application Priority Data
Nov. 25, 2015 (CN) 201510836708.5

(51) Int. Cl. H04N 21/443; H04N 21/472; H04N 21/442; H04N 21/488

(52) U.S. Cl. CPC H04N 21/4436; H04N 21/4882; H04N 21/44218; H04N 21/47217

(57) ABSTRACT

Disclosed is a method and apparatus for automatically turned off video playing, including the steps of monitoring whether there is a viewer before a screen during the playing of a video file; if monitoring that there is no viewer before the screen within a first time threshold, then pausing the now-playing video file playing; and determining whether the paused video file is resumed to play within a second time threshold; if yes, continuing to monitor whether there is a viewer before the screen; if no, turning off the video playing. Thereby, method and apparatus for automatically turned off video playing settled a problem of the video playing continues to play a media playing application when the viewer unconsciously falls asleep.

### CROSS-REFERENCE TO RELATED APPLICATIONS

The present disclosure is a continuation of International Application No. PCT/CN2016/083726 filed on May 27, 2016, which is based upon and claims the priority of Chinese patent application No. 2015108367085, filed on Nov. 25, 2015, and the entire contents thereof are incorporated herein by reference.

### FIELD OF THE APPLICATION

The present disclosure relates to media communication technology, in particular to a method and apparatus for automatically turning off video playing.

### BACKGROUND

With rapid development of multimedia technology, video application technology is used by more and more users. Now, it is an important recreation for watching videos in people's spare time, whether at home or during the travel by vehicle or in other occasions, people can watch the videos by terminals.

In the prior art, when the user watches a video file with the terminal, it is often occurred to forget to exit from the video playing page due to unconscious falling asleep or temporary off the terminal. In this case, the video playing page will continue to play, resulting in a significant energy waste of the terminal. In addition, long time use will bring damages to the terminal and shorten the service life thereof.

### SUMMARY OF DISCLOSURE

In view of this, an object of the disclosure is to provide a method and apparatus for automatically turning off video playing to address the problem that the video playing page continues video playing when the user falls asleep or departs temporarily during the video playing.

Based on the object, an embodiment of the disclosure provides a method for automatically turning off video playing, the method including:

during the playing of a video file, monitoring whether there is a viewer before the screen, if it is monitored that there is no viewer before the screen within a first time threshold, then pausing the video file playing; and

determining whether the paused video file is resumed to play within a second time threshold; if yes, continuing to monitor whether there is a viewer before the screen; if no, turning off the video playing.

Optionally, the method further includes:

after pausing the playing of the video files, starting a screen saver; and

determining whether there is an operation to a terminal; if there is an operation to the terminal, then closing the screen saver and determining whether the paused video file is resumed to play; if there is no operation to the terminal, then turning off the screen saver and turning off the video playing.

Optionally, the method further includes:

before turning off the video playing, displaying a pop-up floating layer on the playing page of the video file to prompt that the video playing will be automatically turned off; and

determining whether the pop-up floating layer prompting the automatically turning off the video playing is cancelled, if yes then resuming to play the paused video file; if no then turning off the video playing.

Optionally, after it is monitored that there is no viewer before the screen, the method further includes:

acquiring a battery power of the terminal for playing the video file, determining whether the battery power is lower than a predetermined power threshold; if it is not lower than the predetermined power threshold, then pausing the video file; if it is lower than the predetermined power threshold, then directly turning off the video playing.

Optionally, monitoring whether there is a viewer before the screen includes:

recognizing an image before the screen by a camera; if it is recognized that there is a face image before the screen, then determining there is a viewer before the screen; if it is recognized that there is no face image before the screen, then determining there is no viewer.

In another aspect of an embodiment of the present disclosure, it is provided an apparatus for automatically turning off video playing, the apparatus including:

a screen monitoring unit, for monitoring whether there is a viewer before a screen during the playing of a video file;

a video pausing unit, for pausing the video file playing, if it is monitored that there is no viewer before the screen within a first time threshold; and

a playing exiting unit, for determining whether the paused video file is resumed to play within a second time threshold; if yes, continuing to monitor whether there is a viewer before the screen; if no, turning off the video playing.

Optionally, the video pausing unit is also used for starting a screen saver after pausing the video file playing;

determining whether there is an operation to a terminal; if there is an operation to the terminal, then closing the screen saver and the video pausing unit being communicated with the video exiting unit so that the video exiting unit determines whether the paused video file is resumed to play, and executes the step of continuing to monitor whether there is a viewer before the screen, or, turning off the video playing based on the result of determination; and

if there is no any operation to the terminal, then closing the screen saver and the video pausing unit being communicated with the video exiting unit, so that the video exiting unit directly turns off the video playing.

Optionally, the video exiting unit is also used for:

displaying a pop-up floating layer on the playing page of the video file to prompt that the video playing will be automatically turned off before turning off the video playing; and

determining whether the pop-up floating layer prompting the automatically turning off the video playing is cancelled, if yes then resuming to play the paused video file; if no then turning off the video playing.

Optionally, the screen monitoring unit is also used for:

acquiring a battery power of the terminal for playing the video file after it is monitored that there is no viewer before the screen, determining whether the battery power is lower than a predetermined power threshold; if the battery power is not lower than the predetermined power threshold, then the screen monitoring unit being communicated with the video pausing unit so that the video pausing unit pauses the video file; if the battery power is lower than the preset power threshold, then the screen monitoring unit being communicated with the playing exiting unit so that the playing exiting unit directly turns off the video playing.

Optionally, monitoring whether there is a viewer before the screen by the screen monitoring unit includes:

recognizing an image before the screen by a camera; if it is recognized that there is a face image before the screen, then determining there is a viewer before the screen; if it is recognized that there is no face image before the screen, then determining there is no viewer.

Another aspect of an embodiment of the present disclosure provides a device, including:

one or more processors; and

a memory for storing instructions;

wherein the one or more processors are configured to read the instructions from the memory to execute the steps of:

during the playing of a video file, monitoring whether there is a viewer before the screen, if it is monitored that there is no viewer before the screen within a first time threshold, then pausing the video file playing; and

determining whether the paused video file is resumed to play within a second time threshold; if yes, continuing to monitor whether there is a viewer before the screen; if no, turning off the video playing.

In a further another aspect of an embodiment of the present disclosure, there is provided a non-transitory computer-readable storage medium storing executable instructions that, when executed by an electronic device, cause the electronic device to:

monitor whether there is a viewer before a screen during playing of a video file;

if it is monitored that there is no viewer before the screen within a first time threshold, then pause the video file playing; and

determine whether the paused video file is resumed to play within a second time threshold; if yes, continuing to monitor whether there is a viewer before the screen; if no, turning off the video playing.

As can be seen from the above, the method and apparatus for automatically turning off video playing provided by the embodiments of the present disclosure can during the playing of video file, monitor whether there is a viewer before the screen, if it is monitored that there is no viewer before the screen within a first time threshold, then pausing the now-playing video file playing; and determine whether the video file which has been paused is started to play again within a second time threshold; if yes, continuing to monitor whether there is a viewer before the screen; if no, turning off the video playing. Thus, it can achieve that the video playing application can monitor the viewer's watching condition and determine to automatically turn off the video playing page, so that the service of video media can be greatly optimized and the user's satisfaction for the video playing application can be improved.

It should be understood that both the general description hereinbefore and the detailed description hereinafter are merely exemplary and explanatory without any limitation to the disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a method for automatically turning off video playing according to the first embodiment of the present disclosure;

FIG. 2 is a schematic flow diagram of a method for automatically turning off video playing according to a referable embodiment of the present disclosure;

FIG. 3 is a schematic view of an apparatus for automatically turning off video playing according to an embodiment of the present disclosure.

FIG. 4 is a schematic view of a device for automatically turning off video playing according to an embodiment of the present disclosure.

By the above drawings, the embodiments of the present disclosure have been shown clearly and will be described hereinafter in more detail. These drawings and description are not intended in any way to limit the scopes of the disclosure, but describe the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

According to the current utilization of multimedia platform, during a user watches a video file, when the user falls asleep or does other things, the playing page of the video file will be still playing until the end, even the exhaustion of the power of the terminal. To solve this problem, the present disclosure started from the user's perspective and found that the user expects the multimedia platform can control the playing of video file. Thus, the idea of the present disclosure is to provide a function of controlling the video playing page by monitoring the viewer's watching condition of video file in the multimedia platform.

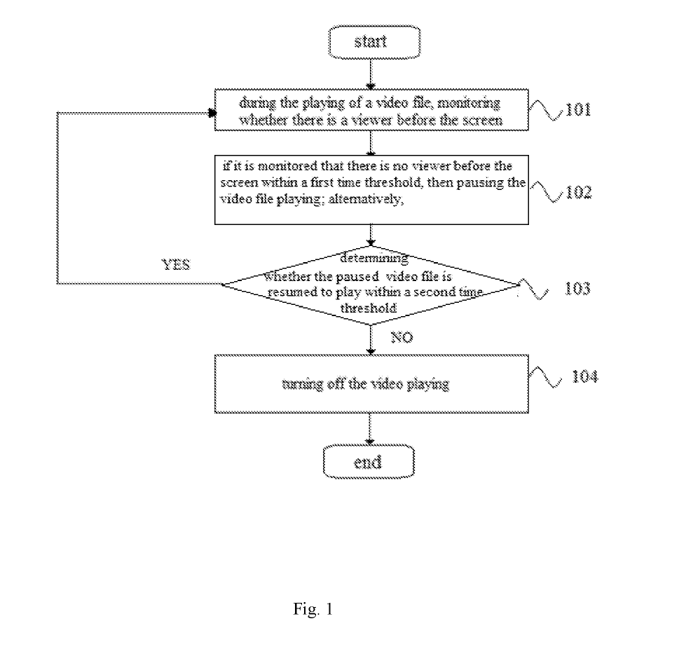

Referring to FIG. 1, a schematic flow diagram of a method for automatically turning off video playing according to the first embodiment of the present disclosure is shown, wherein the method for automatically turning off video playing includes:

Step 101: during the playing of a video file, monitoring whether there is a viewer before the screen, and then jumping to Step 102;

Step 102: if it is monitored that there is no viewer before the screen within a first time threshold, then pausing the video file playing; alternatively, if continuously monitored that there is no viewer before the screen within a first time threshold, then pausing the video file playing.

Step 103: determining whether the paused video file is resumed to play within a second time threshold; if yes, returning to Step 101; if no, jumping to Step 104; and

Step 104: turning off the video playing.

As an embodiment of Step 101, during the playing of a video file, the conditions of a viewer before the screen or no viewer before the screen is monitored, in particular the condition of no viewer before the screen all the time within a first time threshold is monitored, wherein the first time threshold can be predetermined as actually required.

Alternatively, when the condition of no viewer before the screen is monitored continuously, whether Step 102 is executed can be determined based on the predetermined trigger condition, wherein the trigger condition can include no viewer before the screen being monitored twice, thrice, etc. in succession, that is, the monitored frequency of no viewer before the screen can be set arbitrarily; furthermore, the time interval of each monitoring can be set as, e.g., once every 5 minutes.

Alternatively, the monitoring of the viewer before the screen can be implemented by recognizing an image before the screen with a camera installed in the terminal. Optionally, when recognizing a face image with camera, if recognizing there is a face image before the screen then it can determine that there is a viewer before the screen; if recognizing there is no face image before the screen then it can determine there is no viewer before the screen.

As an embodiment of Step 102, it should be understood that after pausing the video file playing, a screen saver can be started. Then it is determined whether there is any operation to the terminal under the running of screen saver; if there is an operation then directly closing the screen saver and executing Step 103; if there is no operation then turning off the screen saver and exiting the playing page of the video file. Alternatively, in the case of there is no operation, a time interval from starting the screen saver to turning off the screen saver can be predetermined as required. Alternatively, the default style of the running screen saver is to protect the video playing page from seeing clearly by such as sheltering the contents of the video playing page, blank screen, or playing of other contents. Thereby, the contents of the video playing page can be protected from watching and the user's privacy can be ensured.

As an embodiment of Step 103, if determining that the paused video file is resumed to play within a second time threshold, then keeping it play normally and continuing to monitor the condition of the viewer before the screen, that is, returning to Step 101; if determining that the paused video file is not resumed to play, then jumping to Step 104; wherein the second time threshold can be predetermined as actually required.

As an embodiment of Step 104, before closing the video playing, a pop-up floating layer can be displayed on the playing page of the video file to prompt that the video playing will be automatically turned off. Then, it is determined whether the pop-up floating layer prompting the automatically turning off the video playing is cancelled, if cancelled then resuming to play the paused video file; if not cancelled then closing the video playing. Alternatively, it can prompt how long until the automatically turned off the video playing in the pop-up floating layer. Of course, the prompted time can be preset as actually required.

It should be noted that in the method for automatically turned off video playing of the present disclosure, after executing Step 101 of continuously monitoring that there is no viewer before the screen and before Step 102 of pausing the video file playing, it can acquire the current battery power of the terminal and determine whether the current battery power is lower than a predetermined threshold. If determining the current batter power greater than or equal to the threshold, then Step 102 of pausing the video file playing is executed. If determining the current battery power is lower than the threshold, then the video playing will be directly closed.

According the above-mentioned embodiments, the method for automatically turned off video playing of the present disclosure can satisfy the process of multi-level execution steps to exit the video playing page, so that it cannot only automatically turn off the video playing, but also can avoid a mistaken closure of the video playing page due to errors in determination process. For example, a viewer may leave only a period of time and then return to the screen, but if the process of exiting the video playing page is only single level at this time, then it may execute the step of exiting the video playing page.

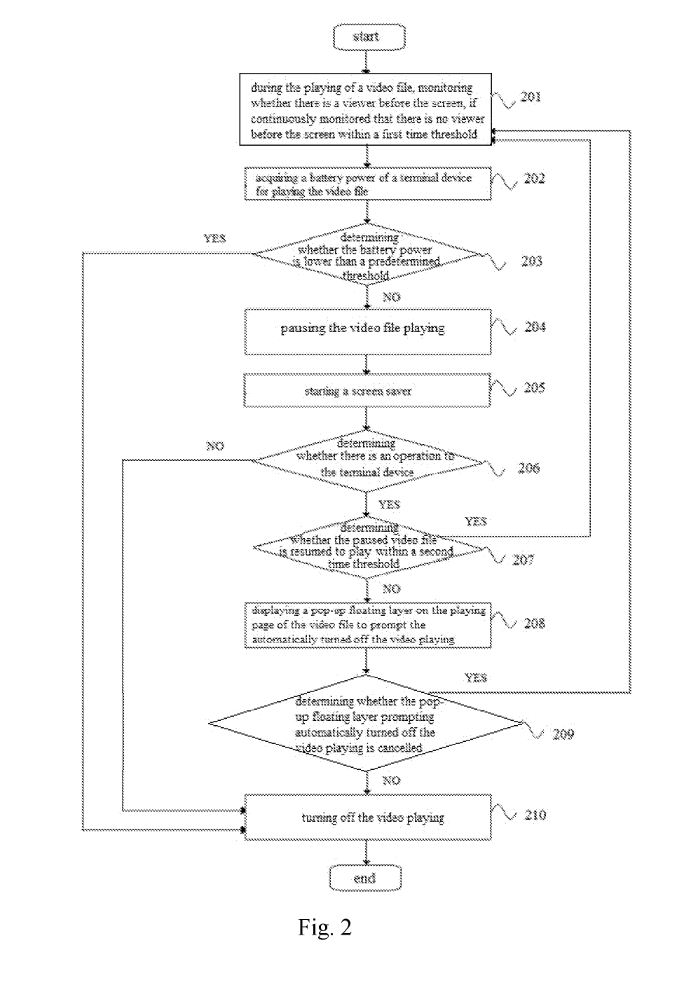

As a referable embodiment, referring to FIG. 2, the method for automatically turned off video playing can specifically include the steps of:

Step 201: during the playing of a video file, monitoring whether there is a viewer before the screen, if continuously monitored that there is no viewer before the screen within a first time threshold, then executing Step 202;

Step 202: acquiring a battery power of a terminal for playing the video file;

Step 203: determining whether the battery power is lower than a predetermined threshold, if the battery power is greater than or equal to the predetermined threshold then executing Step 204, or if the power is lower than the predetermined threshold then executing Step 210;

Step 204, pausing the video file playing;

Step 205, starting a screen saver;

Step 206, determining whether there is an operation to the terminal; if yes, turning off the screen saver and jumping to Step 207; if no, turning off the screen saver and jumping to Step 210;

Step 207, determining whether the paused video file is resumed to play within a second time threshold, if resumed then returning to Step 201, if not then jumping to Step 208;

Step 208, displaying a pop-up floating layer on the playing page of the video file to prompt the automatically turned off the video playing;

Step 209, determining whether the pop-up floating layer prompting automatically turned off the video playing is cancelled, if cancelled then resuming to play the paused video file and returning to Step 201; if not cancelled then executing Step 210; and

Step 210, turning off the video playing.

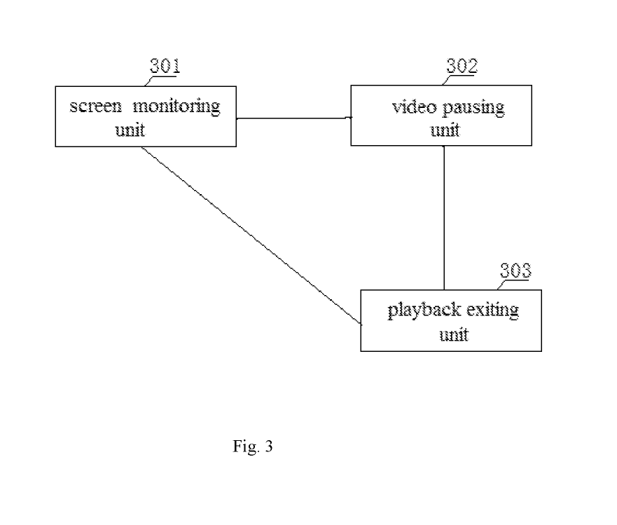

In another aspect of an embodiment of the present disclosure, it is provided an apparatus for automatically turned off video playing as shown in FIG. 3. The apparatus for automatically turned off video playing includes a screen monitoring unit 301, a video pausing unit 302 and a playing exiting unit 303. The screen monitoring unit 301 is used for monitoring whether there is a viewer before the screen during the playing of a video file; the video pausing unit 302 is used for pausing the video file playing, if it is monitored that there is no viewer before the screen within a first time threshold; and the playing exiting unit 303 is used for determining whether the paused video file is resumed to play within a second time threshold; if yes, continuing to monitor whether there is a viewer before the screen; if no, turning off the video playing.

The screen monitoring unit 301 can monitor the condition of a viewer before the screen and no viewer before the screen. When the condition of no viewer before the screen is monitored, the video pausing unit 302 will be triggered to pause the playing video. Alternatively, when the condition of no viewer before the screen is monitored continuously, it will be determined whether the video pausing unit 302 is triggered to pause the video playing based on the predetermined trigger condition. The trigger condition can includes no viewer before the screen being monitored twice, thrice, etc. in succession, that is, the frequency of no viewer monitored before the screen can be set arbitrarily. Furthermore, the time interval of each monitoring can be set as, e.g., once every 5 minutes.

Alternatively, the monitoring of the viewer before the screen can be implemented by recognizing an image before the screen with a camera installed in the terminal. Optionally, when recognizing a face image with camera, if recognizing there is a face image before the screen then can determine that there is a viewer before the screen; if recognizing there is no face image before the screen then can determine there is no viewer before the screen.

As another embodiment of the apparatus of the present disclosure, after continuously monitored that there is no viewer before the screen, the screen monitoring unit 301 can acquire the current battery power of the terminal and determine whether the current battery power is lower than a predetermined threshold. If determining that the current battery power is greater than or equal to the threshold, the screen monitoring unit 301 is communicated with the video pausing unit 302 so that the video pausing unit 302 pauses the video file playing. If determining that the current battery power is lower than the threshold, then the screen monitoring unit 301 is communicated with the playing exiting unit 303 so that the playing exiting unit 303 directly turns off the video playing.

As another referable embodiment of the apparatus of the present disclosure, the video pausing unit 302 can further includes starting a screen saver after pausing the video file playing; determining whether there is any operation to the terminal under the running of screen saver; if there is an operation then directly turning off the screen saver; the video pausing unit 302 being communicated with the playing exiting unit 303 so that the playing exiting unit 303 determines whether the pausing video file is resumed to play and executes the step of continuing to monitor whether there is a viewer before the screen or turning off the video playing based on the result of determination. If there is no operation to the terminal, then turning off directly the video playing and the video pausing unit 302 being communicated with the playing exiting unit 303 so that the playing exiting unit 303 directly turns off the video playing. Alternatively, in the case of there is no operation, a time interval from starting the screen saver to turning off the screen saver can be predetermined as required. Alternatively, the default style of the running screen saver can be to protect the video playing page from seeing clearly.

As an embodiment of the apparatus of the present disclosure, before the playing exiting unit 303 closes the video playing, a pop-up floating layer can be displayed on the playing page of the video file to prompt that the video playing will be automatically turned off. Then, it determines whether the pop-up floating layer prompting the automatically turned off the video playing is cancelled, if cancelled then starting to play the paused video file; if not cancelled then turning off the video playing. Alternatively, it can prompt how long until the automatically turned off the video playing in the pop-up floating layer. Of course, the prompted time can be preset as actually required.

It should be noted that the detailed embodiments of the apparatus for automatically turned off video playing of the present disclosure have been described in detail in the description of the method for automatically turned off video playing hereinbefore, so it is no longer to repeat the description.

In addition, the method and apparatus for automatically turned off video playing of the present disclosure can be applied to various user terminals, e.g., mobile phone, PC, large screen, television and other terminals.

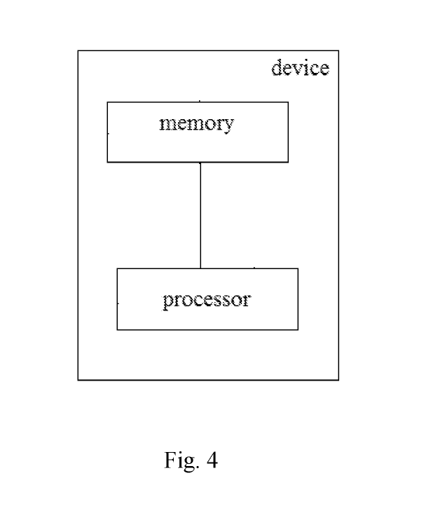

FIG. 4 illustrates a block diagram of an device for executing the method according the disclosure. Another aspect of embodiments of the present disclosure further provides a device, including: one or more processor; and

a memory for storing instructions;

wherein the one or more processors are configured to read the instructions from the memory to execute the steps of:

during the playing of a video file, monitoring whether there is a viewer before a screen, if it is monitored that there is no viewer before the screen within a first time threshold, then pausing the video file playing; and

determining whether the paused video file is resumed to play within a second time threshold; if yes, continuing to monitor whether there is a viewer before the screen; if no, turning off the video playing.

In a further another aspect of an embodiment of the present invention, it is provided a non-transitory computer-readable storage medium storing executable instructions that, when executed by an electronic device with a touch-sensitive display, cause the electronic device to:

monitor whether there is a viewer before a screen during playing of a video file;

if it is monitored that there is no viewer before the screen within a first time threshold, then pause the video file playing; and

determine whether the paused video file is resumed to play within a second time threshold; if yes, continuing to monitor whether there is a viewer before the screen; if no, turning off the video playing.

In some embodiments of the present invention, the non-transitory computer-readable storage medium further including:

after pausing the video file playing, starting a screen saver; and

determining whether there is an operation to a terminal; if there is an operation to the terminal, then closing the screen saver and determining whether the paused video file is resumed to play; if there is no operation to the terminal, then closing the screen saver and turning off the video playing.

In some embodiments of the present invention, the non-transitory computer-readable storage medium further including:

before turning off the video playing, displaying a pop-up floating layer on the playing page of the video file to prompt that the video playing will be automatically turned off; and

determining whether the pop-up floating layer, which prompts that the video playing will be automatically turned off, is canceled; if yes, then resuming to play the paused video file; if no, then turning off the video playing.

In some embodiments of the present invention, wherein after it is monitored that there is no viewer before the screen, the non-transitory computer-readable storage medium further including:

acquiring a battery power of the terminal for playing the video file, determining whether the battery power is lower than a predetermined power threshold; if the battery power is not lower than the predetermined power threshold, then pausing the video file playing; if the battery power is lower than the predetermined power threshold, then directly turning off the video playing.

In some embodiments of the present invention, wherein monitoring whether there is a viewer before the screen, the non-transitory computer-readable storage medium further including:

recognizing an image before the screen by a camera; if it is recognized that there is a face image before the screen, then determining there is a viewer before the screen; if it is recognized that there is no face image before the screen, then determining there is no viewer.

In summary, the method and apparatus for automatically turned off video playing of the present disclosure creatively solved the problems that the media services cannot monitor the viewer's watching condition and cannot automatically close a video playing, so as to achieve the diversity of media services, so that the media services are more relevant and user-friendly. Finally, the method and apparatus for automatically turned off video playing of the present disclosure are simple, compact and easy to implement.

In addition, typically, the apparatus or terminal of the present disclosure can be a variety of electronic terminals such as mobile phone, personal digital assistant (PDA), tablet PC (PAD), smart TV, etc., so that the scope of the disclosure should not be limited to a specific type of apparatus or terminal. The system of the present disclosure can be applied in any one of the above electronic terminal in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and apparatus units can also be implemented with a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct Rambus RAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed with the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for automatically turning off video playing, executed by a terminal, comprising:
monitoring whether there is a viewer before a screen during playing of a video file;
if it is monitored that there is no viewer before the screen within a first time threshold, then pausing the video file playing; and
determining whether the paused video file is resumed to play within a second time threshold; if yes, continuing to monitor whether there is a viewer before the screen; if no, turning off the video playing.

2. The method according to claim 1, wherein the method further comprising:
after pausing the video file playing, starting a screen saver; and
determining whether there is an operation to a terminal; if there is an operation to the terminal, then closing the screen saver and determining whether the paused video file is resumed to play; if there is no operation to the terminal, then closing the screen saver and turning off the video playing.

3. The method according to claim 1, wherein the method further comprising:
before turning off the video playing, displaying a pop-up floating layer on the playing page of the video file to prompt that the video playing will be automatically turned off; and
determining whether the pop-up floating layer, which prompts that the video playing will be automatically turned off, is canceled; if yes, then resuming to play the paused video file; if no, then turning off the video playing.

4. The method according to claim 1, wherein after it is monitored that there is no viewer before the screen, the method further comprising:
acquiring a battery power of the terminal for playing the video file, determining whether the battery power is lower than a predetermined power threshold; if the battery power is not lower than the predetermined power threshold, then pausing the video file playing; if the battery power is lower than the predetermined power threshold, then directly turning off the video playing.

5. The method according to claim 1, wherein monitoring whether there is a viewer before the screen comprising:
recognizing an image before the screen by a camera; if it is recognized that there is a face image before the screen, then determining there is a viewer before the screen; if it is recognized that there is no face image before the screen, then determining there is no viewer.

6. A device, comprising:
one or more processors; and
a memory for storing instructions;
wherein the one or more processors are configured to read the instructions from the memory to execute the steps of:
during the playing of a video file, monitoring whether there is a viewer before a screen, if it is monitored that there is no viewer before the screen within a first time threshold, then pausing the video file playing; and
determining whether the paused video file is resumed to play within a second time threshold; if yes, continuing to monitor whether there is a viewer before the screen; if no, turning off the video playing.

7. The device according to claim 6, wherein the one or more processors are configured to read the instructions from the memory to further execute the steps of:
after pausing the video file playing, starting a screen saver; and
determining whether there is an operation to a terminal; if there is an operation to the terminal, then closing the screen saver and determining whether the paused video file is resumed to play;
if there is no operation to the terminal, then closing the screen saver and turning off the video playing.

8. The device according to claim 6, wherein the one or more processors are configured to read the instructions from the memory to further execute the steps of:
before turning off the video playing, displaying a pop-up floating layer on the playing page of the video file to prompt that the video playing will be automatically turned off; and
determining whether the pop-up floating layer, which prompts that the video playing will be automatically turned off, is cancelled; if yes, then resuming to play the paused video file; if no, then turning off the video playing.

9. The device according to claim 6, the one or more processors are configured to read the instructions from the memory to further execute the steps of:
after it is monitored that there is no viewer before the screen, acquiring a battery power of the terminal for playing the video file, determining whether the battery power is lower than a predetermined power threshold; if the battery power is not lower than the predetermined power threshold, then pausing the video file playing; if the battery power is lower than the predetermined power threshold, then directly turning off the video playing.

10. The device according to claim 6, the one or more processors are configured to read the instructions from the memory to further execute the steps of:
recognizing an image before the screen by a camera; if it is recognized that there is a face image before the screen, then determining there is a viewer before the screen; if it is recognized that there is no face image before the screen, then determining there is no viewer.

11. A non-transitory computer-readable storage medium storing executable instructions that, when executed by an electronic device, cause the electronic device to:
monitor whether there is a viewer before a screen during playing of a video file;
if it is monitored that there is no viewer before the screen within a first time threshold, then pause the video file playing; and
determine whether the paused video file is resumed to play within a second time threshold; if yes, continuing to monitor whether there is a viewer before the screen; if no, turning off the video playing.

12. The non-transitory computer-readable storage medium according to claim 11, further comprising:
after pausing the video file playing, starting a screen saver; and
determining whether there is an operation to a terminal; if there is an operation to the terminal, then closing the screen saver and determining whether the paused video file is resumed to play; if there is no operation to the terminal, then closing the screen saver and turning off the video playing.

13. The non-transitory computer-readable storage medium according to claim 11, further comprising:
before turning off the video playing, displaying a pop-up floating layer on the playing page of the video file to prompt that the video playing will be automatically turned off; and
determining whether the pop-up floating layer, which prompts that the video playing will be automatically turned off, is canceled; if yes, then resuming to play the paused video file; if no, then turning off the video playing.

14. The non-transitory computer-readable storage medium according to claim 11, wherein after it is monitored that there is no viewer before the screen, further comprising:
acquiring a battery power of the terminal for playing the video file, determining whether the battery power is lower than a predetermined power threshold; if the battery power is not lower than the predetermined power threshold, then pausing the video file playing; if the battery power is lower than the predetermined power threshold, then directly turning off the video playing.

15. The non-transitory computer-readable storage medium according to claim 11, wherein monitoring whether there is a viewer before the screen comprising:
recognizing an image before the screen by a camera; if it is recognized that there is a face image before the screen, then determining there is a viewer before the screen; if it is recognized that there is no face image before the screen, then determining there is no viewer.
